(19) United States
(12) Patent Application Publication
(10) Pub. No.: US 2008/0216478 A1
(43) Pub. Date: Sep. 11, 2008

(54) INTEGRATION OF A WATER-SPLITTING PROCESS WITH PRODUCTION OF FERTILIZER PRECURSORS

(75) Inventor: Robert S. Cherry, Idaho Falls, ID (US)

Correspondence Address: BATTELLE ENERGY ALLIANCE, LLC, P.O. BOX 1625, IDAHO FALLS, ID, 83415-3899, US

(73) Assignee: Battelle Energy Alliance, LLC, Idaho Falls, ID (US)

(21) Appl. No.: 11/682,631

(22) Filed: Mar. 6, 2007

(51) Int. Cl. C01B 17/80; C01B 17/69; C01B 21/28; C01B 21/38

(52) U.S. Cl. 60/641.2; 423/235; 423/243.03; 60/641.1; 60/641.8; 60/721

(57) ABSTRACT

Methods and apparatus for the integration of a water splitting process with the production of fertilizer precursors such as ammonia, nitric acid, and sulfuric acid are provided. At least one of heat and electricity from a power plant are used to split water into hydrogen gas and oxygen gas. Nitrogen gas is provided by air separation. The hydrogen gas and nitrogen gas are used to produce ammonia. The ammonia and oxygen gas are used to produce nitric acid. The oxygen gas, water, and sulfur are used to produce sulfuric acid. Further disclosed is an apparatus for the production of nitric acid comprising a power plant and an apparatus for the production of nitric acid. Also disclosed is an apparatus for the production of sulfuric acid comprising a power plant and an apparatus for the production of sulfuric acid.

### GOVERNMENT RIGHTS

The United States Government has certain rights in this invention pursuant to Contract No. DE-AC07-051D14517 between the United States Department of Energy and Battelle Energy Alliance, LLC.

### FIELD OF THE INVENTION

The present invention relates generally to the production of fertilizer precursors. More specifically, the present invention relates to production of nitric acid, ammonia and sulfuric acid using a water-splitting process to produce hydrogen and oxygen.

### BACKGROUND OF THE INVENTION

Global ammonia consumption was about 132 million tons in 2004. The major markets are China at 38 million tons and Russia, India, and the U.S. at 11 million tons each. The U.S. has 34 ammonia plants which, because of high domestic natural gas costs, ran at 59% of total rated capacity in 2003.

Currently, ammonia is conventionally commercially produced using a process that consumes natural gas. However the use of natural gas introduces supply uncertainties, requires expensive scrubbing and emissions cleaning equipment, is subject to feedstock cost fluctuations, and results in substantial CO₂ emissions. Processes for making ammonia and other fertilizer components or precursors, which reduce dependence on natural gas, would constitute an improvement in the art.

### BRIEF SUMMARY OF THE INVENTION

An embodiment of a method for generating nitric acid according the present invention comprises providing at least one of heat and electricity from a power plant and using the at least one of heat and electricity to split water into hydrogen gas and oxygen gas. The hydrogen gas and nitrogen gas are used to produce ammonia. The ammonia and the oxygen gas are used to produce nitric acid.

An embodiment of a method for generating sulfuric acid according the present invention comprises providing at least one of heat and electricity from a power plant and using the at least one of heat and electricity to split water into hydrogen gas and oxygen gas. The oxygen gas, water, and sulfur are used to produce sulfuric acid.

An embodiment of an apparatus for the production of nitric acid comprises a power plant configured to provide at least one of electricity, heat, high pressure steam, high pressure helium, or turbine motive fluid to a water splitting production center. The water splitting production center is configured to provide an oxygen gas stream to a nitric acid production center and a hydrogen gas stream to an ammonia production center. An air separation production center is configured to supply a nitrogen gas stream to the ammonia production center. The ammonia production center is configured to supply ammonia to the nitric acid production center.

An embodiment of an apparatus for the production of sulfuric acid comprises a power plant configured to provide at least one of electricity, heat, high pressure steam, high pressure helium and turbine motive fluid to a water splitting production center. The water splitting production center is configured to provide an oxygen gas stream to a sulfuric acid production center.

### BRIEF DESCRIPTION OF THE DRAWINGS

It will be appreciated by those of ordinary skill in the art that the elements depicted in the various drawings are for purposes of example only. The nature of the present invention, as well as other embodiments of the present invention, may be more clearly understood by reference to the following detailed description of the invention, to the appended claims, and to the several drawings, in which

FIG. 1 is a schematic diagram of an embodiment of an integrated process flow according to the present invention.

FIG. 2 is a schematic diagram of an embodiment of the balance of the relative molar flows of starting materials and products from the integrated process flow according to FIG. 1.

### DETAILED DESCRIPTION OF THE INVENTION

In embodiments of the present invention, resources or outputs of an electrical power plant are used to split water and generate a hydrogen gas stream and an oxygen gas stream. In further embodiments, the power plant may be a coal fired, gas fired, oil fired, geothermal, ocean thermal, ocean tidal, solar, wind, nuclear, or hydroelectric power plant. In a broad sense, the plant may comprise a renewable or a non-renewable energy plant, including without limitation a plant employing any type of fossil fuel.

In further embodiments, one or more of electrical power, steam, motive force, and heat from a power plant may be used to split water. Examples of processes that may be used to split water into hydrogen gas and oxygen gas include, but are not limited to, electrolysis, thermolysis, high temperature (steam) electrolysis, and thermochemical cycles. Examples of thermochemical processes include, but are not limited to, sulfur-iodine processes, hybrid sulfur cycles, Ca—Br—Fe or modified Ca—Br cycles, and other cycles.

In further embodiments, an air separation plant may be used to separate a nitrogen gas stream from ambient air. The remaining gas after nitrogen separation may be used to form an oxygen-enriched air gas stream. Examples of processes by which nitrogen may be separated from air include, but are not limited to, cryogenic distillation, ambient temperature adsorption, and membrane separation. In an embodiment, the input power and/or energy required to separate air may come from the power plant that is used to separate water. In further embodiments, the nitrogen gas stream may, in whole or in part, be generated by a chemical process that releases nitrogen gas.

In some embodiments, the hydrogen gas stream and the nitrogen gas stream may be combined to generate ammonia according to the process of reaction (1):

N₂(g)+3H₂(g)→2NH₃(g)+heat (1)

Examples of processes that may be used to make ammonia from a hydrogen gas stream and a nitrogen gas stream include, but are not limited to, the Haber-Bosch process, portions of the Kellogg Advanced Ammonia Process, and/or nitrogen synthesis loops. Examples of catalysts useful in the creation of ammonia from hydrogen and nitrogen include, but are not limited to, metallic iron, iron containing species, and/or ruthenium. Where iron and/or iron-containing species are used, aluminum, calcium, magnesium, and potassium compounds such as, but not limited to aluminum oxide and potassium oxide, may be used as promoters.

The pressures at which a process according to reaction (1) may take place include, but are not limited to, from about 800 psi to about 3700 psi; about 2000 psi to about 3000 psi; and about 2600 psi. In some embodiments, the incoming hydrogen gas stream and nitrogen gas stream may be pressurized before or after being combined. The enthalpy change of reaction (1) is −92.4 kJ/mol at 25° C. and, thus, the process is exothermic. In one embodiment of the present invention, the process according to reaction (1) may occur at a temperature between about 350° C. and about 550° C.

In further embodiments, ammonia production may take place in a series of one or more reactors. In some embodiments, coolers or heat exchangers may be installed between reactors in order to drop the temperature of the reactants as they pass between the reactors. In an additional embodiment, after the reactants have passed through one or more reactors, the mixture may be cooled, allowing the ammonia to condense and be collected. In still further embodiments, one or more reactors may have cooling elements or heat exchangers associated with them so that all or part of the contents of the reactor may be cooled. In other embodiments, any unreacted hydrogen or nitrogen may be fed back into the start of the process. The unreacted hydrogen or nitrogen may be compressed, heated, and/or cooled before being fed back into the start of the process.

In various embodiments, cooling or heating apparatus may be used to control the temperature of the reactants, the reaction vessels, or both. In some embodiments, heat generated from the production of ammonia may be recaptured, for example, using a heat exchanger, and may be used for other purposes. Recaptured heat may, for example, may be used, in whole or in part, to raise steam to drive compressors for compressing the incoming gas streams or for cooling. In further embodiments, heat recovered from the generation of ammonia may be fed back to a power plant and used to generate electricity, or may generate electricity, for example, through the use of a boiler and a turbine driven electrical generator. In additional embodiments one or more of high pressure steam, helium, or turbine motive fluid from a power plant may be used to drive compressors for compressing the incoming gas streams or for cooling purposes.

In a further embodiment, the ammonia generated may be combined with all or part of the oxygen gas stream and/or the oxygen-enriched air gas stream in order to create nitric acid. In one embodiment, the creation of nitric acid may follow from reactions (2)-(4).

4NH₃+5O₂→4NO+6H₂O (2)

2NO+O₂→2NO₂ (3)

3NO₂+H₂O→2HNO₃+NO (4)

In embodiments of the invention, the chemical reaction according to reaction (2) may be performed with the assistance of a catalyst. Examples of catalysts useful in the creation of nitric oxide according to reaction (2) include, but are not limited to, platinum, rhodium, palladium, and mixtures thereof. In embodiments of the invention, the chemical reaction according to reaction (2) may be performed at temperatures of, for example, but not limited to, above 500° C.; from about 800° C. to about 940° C.; from about 810° C. to about 850° C.; from about 850° C. to about 900° C.; and/or from about 900° C. to about 940° C.

In embodiments of the invention, the resulting products from reaction (2) may be cooled and nitric oxide further oxidized to form nitrogen dioxide as outline in reaction (3). In some embodiments, the products resulting from reaction (2) may be cooled to about 150° C. or less and the nitric oxide further oxidized to form nitrogen dioxide as outlined in reaction (3). In some embodiments, nitrogen dioxide may be in equilibrium with dinitrogen tetroxide.

In further embodiments, nitrogen dioxide may be absorbed into water to form nitric oxide and nitric acid according to reaction (4).

In some embodiments, the production of nitric acid from nitrogen dioxide may take place in the gas phase according to reaction (5)

4NO₂+O₂+H₂O→4HNO₃ (5)

In further embodiments of the invention, the chemical reactions according to reactions (2), and (4) or (5) may be performed as a single pressure process or as dual pressure process. In embodiments of a single pressure process, the chemical reactions to according to reactions (2), and (4) or (5) may be performed at pressures of, for example, but not limited to, from about 44 psi to about 88 psi; or from about 102 psi to about 174 psi. In embodiments of a dual pressure process, the chemical reaction according to reactions (2) may be performed at pressures of, for example, but not limited to, from about 44 psi to about 88 psi; and the chemical reactions to reactions (4) or (5) may be performed at pressures of, for example, but not limited to, from about 160 psi to about 218 psi; In additional embodiments, the reactions outlined in reactions (2)-(5) may each take place at the same pressure, different pressures, or any combination thereof. In further example embodiments, the reactions outlined in reactions (2)-(5) may each take place at the same temperature, different temperatures, or any combination thereof.

In various embodiments, the chemical processes outlined in each of reactions (2)-(5) are exothermic in nature. In some embodiments, cooling or heating apparatus may be used to control the temperature of the reactants, the reaction vessels, or both. In further embodiments, heat generated from the reactions according to any of reactions (2)-(5) may be recaptured using, for example, a heat exchanger, and may be used for other purposes. Recaptured heat may, for example, may be used, in whole or in part, to raise steam to drive compressors for compressing the incoming gas streams or for cooling. In further embodiments, heat recovered from the reactions according to any of reactions (2)-(5) may be fed back to a power plant and used to generate electricity, or may generate electricity, for example, through the use of a boiler and a turbine driven electrical generator. In additional embodiments, high pressure steam, helium, and/or turbine motive fluid from a power plant may be used to drive compressors for compressing the incoming gas streams, or for cooling purposes.

In embodiments of the present invention, any nitric oxide produced according to reaction (4) or through any other chemical reaction may be recycled and used to generate additional nitrogen dioxide, for example according to reaction (3).

In some embodiments, side reactions leading to the production of other chemical compounds may occur. Examples of compounds that may be created include, but are not limited to, N₂O and NO_{X}. In embodiments of the present invention, these compounds may be allowed in accumulate during the creation of nitric acid, may be emitted as tail gas, and/or may be absorbed or abated using techniques known in the art. Examples of techniques for absorbing or abating NO_{X} include, but are not limited to, extended absorption into chilled water, catalytic reduction with NH₃, and noncatalytic reduction with hydrocarbon fuels such as propane or natural gas.

In additional embodiments, the nitric acid may be further distilled or concentrated.

In further embodiments, sulfur may be combined with all or part of the oxygen gas stream and/or the oxygen-enriched air gas stream in order to create sulfuric acid. In various embodiments, the creation of nitric acid may follow from reactions (6)-(8).

S+O₂SO₂ (6)

O₂+2SO₂→2SO₃ (7)

SO₃+H₂O→H₂SO₄ (8)

In some embodiments of the present invention, the process depicted in reaction (8) may be replaced with the following process, as outlined in reactions (9) and (10).

H₂SO₄+SO₃H₂S₂O₇ (9)

H₂S₂O₇+H₂O→2H₂SO₄ (10)

In embodiments of the invention, the process according to reaction (6) is conducted through the burning (combustion) of sulfur. Although pure sulfur is depicted in reaction (6) other embodiments of the invention utilize alternate sulfur sources, such as, but not limited to, pyrites, sulfide ores, organic acids, organic spent acids, spent sulfuric acid, diluted sulfuric acid, sulfur containing gases, hydrogen sulfide, and sulfate salts.

In some embodiments, molten sulfur is atomized before combustion. In further embodiments, the sulfur is atomized with a pressure spray nozzle operating at approximately 150 psi or higher. In some embodiments, molten sulfur is at a temperature of, for example, but not limited to, from about 135° C. to about 155° C.; or about 150° C. In additional embodiments, a combustion chamber, for the combustion of sulfur according to reaction (6) is kept at, heated to, or preheated to a temperature of, for example, but not limited to, about from 400° C. to about 425° C. In further embodiments, the combustion according to reaction (6) may occur at a pressure of, for example, but not limited to, from about 20 psi to about 25 psi. In various embodiments, the sulfur dioxide may be cleaned, purified, and/or dried.

In embodiments of the invention, sulfur dioxide may be oxidized according to process in reaction (7) to generate sulfur trioxide. In some embodiments, the process according to reaction (7) may be performed with the assistance of a catalyst. Examples of catalysts useful in the creation of sulfur trioxide according to the process of reaction (7) include, but are not limited to, vanadium, vanadium oxides, V₂O₅, platinum, cesium, alkali, alkali oxides, and mixtures thereof.

In embodiments of the invention, the process of reaction (7) may be performed at temperatures of, for example, but not limited to, more than about 385° C.; from about 385° C. to about 630° C.; or about 450° C. In some embodiments, the process according to reaction (7) may occur at pressures of, for example, but not limited to, from about 15 psi to about 29 psi. In some embodiments, the products of the process of reaction (7) may be cooled. In various embodiments, the products of the process of reaction (7) may be cooled to, for example, but not limited to, about 500° C.; from about 430° C. to about 450° C.; from about 165° C. to about 230° C.; or from about 75° C. to about 80° C.

In further embodiments, sulfur trioxide production can take place in a series of one or more reactors. In one embodiment, an H₂SO₄ absorber and/or an H₂S₂O₇ (oleum) absorber may be placed between or after the one or more reactors. In further embodiments, sulfur trioxide may be absorbed by H₂SO₄ absorber or an H₂S₂O₇ absorber so as to generate H₂S₂O₇ as outlined in reaction (9).

In embodiments of the invention, sulfur trioxide may be absorbed into water according to the process outlined in reaction (8) in order to generate sulfuric acid. In further embodiments, oleum may be absorbed into water according to the process outlined in reaction (10) in order to generate sulfuric acid. In some embodiments, the sulfur trioxide or oleum may be absorbed into water using, for example, but not limited to, one or more absorption towers and/or one or more intermediate absorbers.

In additional embodiments, cooling systems may be installed between reactors in order to drop the temperature of the reactants as they pass between reactors. In additional embodiments, one or more reactors may have cooling elements associated with them so that all or part of the contents of the reactor may be cooled.

In an embodiment of the present invention, heat generated from the production of sulfur dioxide, sulfur trioxide, oleum, and/or sulfuric acid may be recaptured using, for example, a heat exchanger, and may be used for other purposes. Recaptured heat may, for example, may be used, in whole or in part, to raise steam to drive compressors for compressing the incoming gas streams or for cooling. In further embodiments, heat recovered may be fed back to a power plant and used to generate electricity, or may generate electricity, for example, through the use of a boiler and a turbine driven electrical generator. In additional embodiments, one or more of high pressure steam, helium, and turbine motive fluid from a power plant may be used to drive compressors for compressing the incoming gas streams or for cooling purposes.

In additional embodiments of the present invention, one or more of ammonia, nitric acid, and sulfuric acid generated may be used to produce fertilizers. In further embodiments, one or more of ammonia, nitric acid, and sulfuric acid generated may be used as the starting materials for acid neutralization and granulation plants.

As is apparent to one of ordinary skill in the art, the above described processes, temperature ranges, pressure ranges, and equipment may be altered or rearranged in order to comply with the myriad different ways for performing these processes. As such one of ordinary skill in the art would understand that the above described processes, temperature ranges, pressure ranges, and equipment are merely illustrative in nature. Many of the these processes and their alternatives can be found described in the Kirk-Othmer Encyclopedia of Chemical Technology, the entirety of the contents of which are incorporated herein by this reference.

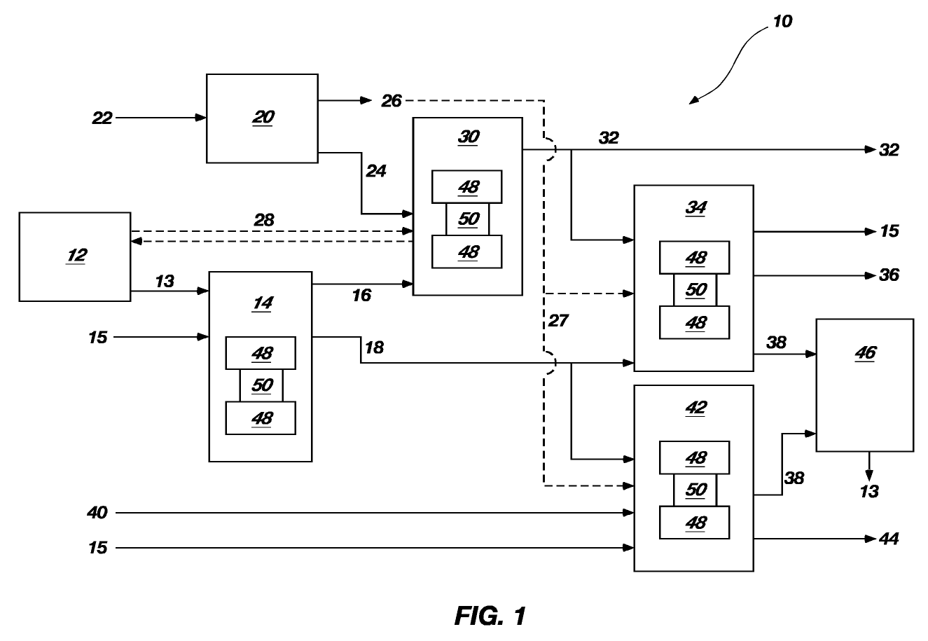

Depicted in FIG. 1, is a block diagram an embodiment of an apparatus 10 according to the present invention. Depicted therein is an electrical production center 12 that is configured for generating one or more of heat, electricity, and a turbine motive fluid. Examples of electrical production center 12 include, but are not limited to, coal fired, gas fired, oil fired, geothermal, ocean thermal, ocean tidal, solar, wind, nuclear, hydroelectric, and other renewable and non-renewable energy-fueled plants, including plants using any type of fossil fuel.

Electrical production center 12 may be configured for and is shown providing electricity 13 to water splitting production center 14, which utilizes incoming water 15 and feeds a hydrogen gas stream into hydrogen gas conduit 16 and an oxygen gas stream into an oxygen gas conduit 18. Water splitting production center 14 may be configured to provide hydrogen gas and/or oxygen gas to one or more other production centers. As will be appreciated by one of skill in the art, water splitting production center 14 may use any of the methods or equipment for splitting water as previously described herein, or any methods or equipment for splitting water known in the art. Further depicted is air separation production center 20, which takes incoming air 22, and separates it to produce a nitrogen gas stream that is fed into a nitrogen gas conduit 24 and an oxygen-enriched air gas stream (nitrogen-depleted air) 26 which may be fed into a oxygen-enriched air conduit 27. Air separation production center 20 may be configured to provide the nitrogen gas stream to another production center. As will be appreciated by one of ordinary skill in the art, air separation production center 20 may use any of the methods or equipment for separating air as previously described herein, or any methods or equipment for separating air known in the art.

Hydrogen gas conduit 16, nitrogen gas conduit 24, and, optionally, turbine motive fluid 28 are connected to ammonia production center 30 which, in turn, produces ammonia 32. Ammonia production center 30 may be configured to provide ammonia to another production center. As will be appreciated by one of skill in the art, ammonia production center 30 may use any of the methods or equipment for producing ammonia previously described herein, or any methods or equipment for producing ammonia known in the art. Ammonia 32 along with oxygen from oxygen gas conduit 16 are provided to nitric acid production center 34, which produces water 15, nitric acid 26, and heat 38. The oxygen-enriched air gas stream 26 from oxygen-enriched air conduit 27 may also be used as a source of oxygen. As will be appreciated by one of skill in the art, nitric acid production center 34 may use any of the methods or equipment for producing nitric acid previously described herein, or any methods or equipment for producing nitric acid known in the art.

As further depicted, water 15, oxygen from oxygen gas conduit 16, and sulfur 40 are provided to sulfuric acid production center 42, which produces sulfuric acid 44 and heat 38. The oxygen-enriched air gas stream 26 from oxygen-enriched air conduit 27 may also be used as a source of oxygen. As will be appreciated by one of skill in the art, sulfuric acid production center 42 may use any of the methods or equipment for producing sulfuric acid previously described herein, or any methods or equipment for producing sulfuric acid known in the art. Heat 38 is provided to power system 46, which may comprise a boiler, and which converts heat 38 to electricity 13. In embodiments, power system 46 may be the same or different from electrical production center 12.

Further depicted in FIG. 1 are one or more reaction vessels 48 associated with the ammonia production center, the nitric acid production center, as well as the sulfuric acid production center. As will be apparent to one of skill in the art, although two reaction vessels 48 are depicted, many embodiments will require only a single reaction vessel. Further depicted is a temperature adjustment apparatus 50 which may be, for example, but not limited to, a heat exchanger, a cooling apparatus, and/or a heating apparatus. Though temperature adjustment apparatus 50 is shown between two reaction vessels 48, it will be apparent to one of ordinary skill in the art that temperature adjustment apparatus 50 may be associated with a single reaction vessel 48. In further embodiments, the temperature adjustment apparatus 50 may be operatively positioned to adjust the temperature of materials as they pass between one or more reaction vessels 48, or may be configured so as to adjust the temperature of a reaction vessel 48 itself or the contents of reaction vessel 48.

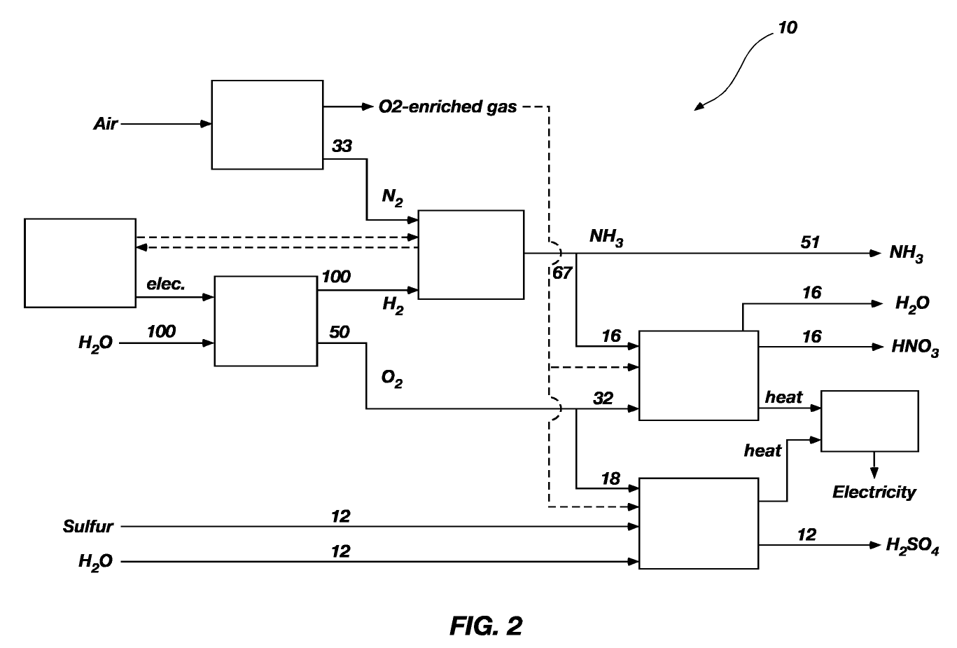

Depicted in FIG. 2. is an example of apparatus 10 of FIG. 1 with an example of a balance of relative molar flow rates for the various products indicated thereon. The reference numerals used in FIG. 1 are removed in FIG. 2 to eliminate confusion with the molar flow rate numbers. As will be appreciated by one of ordinary skill in the art, the balance of products and molar flow rates may be adjusted as desired by adjusting the various inputs and consumptions of each production center's products.

In various embodiments, the different production centers may be consolidated at a single site, at multiple sites, or a combination thereof. As will be apparent to one of ordinary skill in the art, although various production centers are shown in FIGS. 1 and 2, the various production centers need not be present in all contemplated embodiments of the invention, as the raw materials provided by, or products created by those production centers may be obtained from other sources and/or other processes.

While this invention has been described in the context of certain embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of generating nitric acid, the method comprising:
providing at least one of heat and electricity from a power plant;
using the at least one of heat and electricity to split water into hydrogen gas and oxygen gas;
using the hydrogen gas and nitrogen gas to produce ammonia; and
producing nitric acid using the ammonia and the oxygen gas.

2. The method according to claim 1, wherein providing at least one of heat and electricity from a power plant comprises providing at least one of heat and electricity from a nuclear power plant.

3. The method according to claim 1, wherein providing at least one of heat and electricity from a power plant comprises providing at least one of heat and electricity from a power plant selected from the group consisting of fossil fuel, geothermal, ocean thermal, ocean tidal, solar, wind, and hydroelectric power plants.

4. The method according to claim 1, further comprising using heat generated from at least one of the producing ammonia and the producing nitric acid to generate electricity.

5. The method according to claim 1, wherein using at least one of heat and electricity to split water into hydrogen gas and oxygen gas comprises using a sulfur-iodide process.

6. The method according to claim 1, wherein using the hydrogen gas and the nitrogen gas to produce ammonia from comprises using a Haber-Bosch process.

7. The method according to claim 1, wherein using the hydrogen gas and the nitrogen gas to produce ammonia comprises using a single pressure process or a dual pressure process.

8. The method according to claim 1, further comprising
providing at least one of steam, helium, and turbine motive fluid from the power plant at high pressure to drive a compressor; and
compressing at least one of the nitrogen gas, the hydrogen gas, and the oxygen gas prior to producing nitric acid.

9. A method of generating sulfuric acid, the method comprising:
providing at least one of heat and electricity from a power plant;
using the at least one of heat and electricity to split water into hydrogen gas and oxygen gas; and
using the oxygen gas, sulfur, and water to produce sulfuric acid.

10. The method according to claim 9, wherein providing at least one of heat and electricity from a power plant comprises providing at least one of heat and electricity from a nuclear power plant.

11. The method according to claim 9, wherein providing at least one of heat and electricity from a power plant comprises providing at least one of heat and electricity from a power plant selected from the group consisting of fossil fuel, geothermal, ocean thermal, ocean tidal, solar, wind, nuclear, and hydroelectric power plants.

12. The method according to claim 9, further comprising using heat generated from the producing sulfuric acid to generate electricity.

13. The method according to claim 9, wherein the using the oxygen gas, sulfur, and water to produce sulfuric acid comprises using a vanadium oxide catalyst.

14. The method according to claim 9, using the oxygen gas, sulfur, and water to produce sulfuric acid comprises producing oleum.

15. The method according to claim 9, further comprising
providing at least one of steam, helium, and turbine motive fluid from the power plant at high pressure to drive a compressor; and
compressing the oxygen gas stream with the compressor prior to producing sulfuric acid.

16. An apparatus for the production of nitric acid, the apparatus comprising:
a power plant configured to provide at least one of electricity, heat, high pressure steam, high pressure helium, or turbine motive fluid to
a water splitting production center configured to provide an oxygen gas stream to a nitric acid production center and a hydrogen gas stream to an ammonia production center; and
an air separation production center configured to supply a nitrogen gas stream to the ammonia production center;
wherein the ammonia production center is configured to supply ammonia to the nitric acid production center.

17. The apparatus of claim 16, wherein the power plant is a nuclear power plant.

18. The apparatus of claim 16, wherein the power plant is selected from the group consisting of fossil fuel, geothermal, ocean thermal, ocean tidal, solar, wind, and hydroelectric power plants.

19. The apparatus of claim 16 wherein at least one of the ammonia production center and the nitric acid production center comprises at least one reaction vessel and wherein at least one of a heat exchanger, a cooling device, and a heating device is operably linked to the at least one reaction vessel.

20. The apparatus of claim 19 further comprising a boiler operably linked to the heat exchanger and wherein the boiler is configured to provide motive power to an electrical generator.

21. The apparatus of claim 16, wherein the air separation production center is further configured to supply an oxygen-enriched air gas stream to the nitric acid production center

22. The apparatus of claim 16, further comprising at least one of
a nitrogen gas conduit connecting the air separation production center and the ammonia production center;
a hydrogen gas conduit connecting the water splitting production center and the ammonia production center; and
an oxygen gas conduit connecting the water splitting production center and the nitric acid production center.

23. The apparatus of claim 16, wherein the ammonia production center comprises a plurality of reaction vessels with at least one of a cooling apparatus and heat exchanger disposed between the reaction vessels.

24. The apparatus of claim 16, wherein the nitric oxide production center comprises two or more reaction vessels operable at different pressures.

25. An apparatus for the production of sulfuric acid, the apparatus comprising:
a power plant configured to provide at least one of electricity, heat, high pressure steam, high pressure helium, or turbine motive fluid to
a water splitting production center configured to provide an oxygen gas stream to a sulfuric acid production center.

26. The apparatus of claim 25, wherein the power plant is a nuclear power plant.

27. The apparatus of claim 25, herein the power plant is selected from the group consisting of fossil fuel, geothermal, ocean thermal, ocean tidal, solar, wind, nuclear, and hydroelectric fuel power plants.

28. The apparatus of claim 25 wherein the sulfuric acid production center comprises at least one reaction vessel and wherein at least one of a heat exchanger, a cooling device, and a heating device is operably linked to the at least one reaction vessel.

29. The apparatus of claim 28 further comprising a boiler operably linked to the heat exchanger and wherein the boiler configured to drive an electrical generator.

30. The apparatus of claim 25 wherein the nitric acid production center comprises a catalyst comprising a vanadium oxide.

31. The apparatus of claim 25, further comprising an air separation production center configured to supply an oxygen-enriched air gas stream to the sulfuric acid production center
